(19) United States
(12) Patent Application Publication
(10) Pub. No.: US 2009/0046938 A1
(43) Pub. Date: Feb. 19, 2009

(54) Character contour correction

(75) Inventor: Gabriel J. Yoder, Endicott, NY (US)

Correspondence Address: TAROLLI, SUNDHEIM,;COVELL & TUMMINO LLP, Suit 1700, 1300 East Ninth Street, Cleveland, OH, 44114, US

(73) Assignee: Lockheed Martin Corporation

(21) Appl. No.: 11/893,259

(22) Filed: Aug. 15, 2007

(51) Int. Cl. G06T 9/20

(52) U.S. Cl. 382/242

(57) ABSTRACT

Systems and methods are presented for correcting contours of alphanumeric characters. At least one string of numbers that characterizes a given contour of an alphanumeric character is generated. Each number within the string of numbers represents a direction of transition between consecutive pixels in the contour. Sets of consecutive numbers within the string that represent defects in the contour are identified. The identified sets of consecutive numbers are replaced with corrected sets of at least one consecutive number to produce a corrected at least one string of numbers.

### FIELD OF THE INVENTION

The present invention is directed generally to image processing systems and is particularly directed to the correction of contours in alphanumeric characters.

### BACKGROUND OF THE INVENTION

In some applications, a limited amount of time is available to make a decision about any one envelope that is input into the mail stream. For example, data on an envelope or package must be scanned, located, and recognized in a period on the order of one hundred milliseconds to maintain the flow of mail through the system. These time constraints limit the available solutions for accurately classifying and verifying text, such as the zip code and metermarked postage, on an envelope.

### SUMMARY OF THE INVENTION

In accordance with one aspect of the present invention, a method is provided for correcting contours of alphanumeric characters. At least one string of numbers that characterizes a given contour of an alphanumeric character is generated. Each number within the string of numbers represents a direction of transition between consecutive pixels in the contour. Sets of consecutive numbers within the string that represent defects in the contour are identified. The identified sets of consecutive numbers are replaced with corrected sets of at least one consecutive number to produce a corrected at least one string of numbers.

In accordance with another aspect of the present invention, an optical character recognition system includes a binarization element that binarizes the digital image. A character preprocessor includes a contour coder that generates at least one string of numbers that characterizes a given contour of an alphanumeric character, such that each number within the string of numbers represents a direction of transition between consecutive pixels in the contour. The character preprocessor further includes a rule-based processor that identifies sets of consecutive numbers within the string that represent defects in the contour and replaces the identified sets of consecutive numbers with corrected sets of at least one consecutive number to produce a corrected at least one string of numbers. A feature extractor extracts respective sets of features from the corrected plurality of images. A pattern recognition classifier classifies each of the plurality of images as an alphanumeric character according to its associated set of extracted features.

In accordance with yet another aspect of the present invention, a computer readable medium is provided for correcting contours of alphanumeric characters. A contour coder generates at least one string of numbers that characterizes a given contour of an alphanumeric character. Each number within the string of numbers represents a direction of transition between consecutive pixels in the contour. A rule-based processor identifies sets of consecutive numbers within the string that represent defects in the contour and replaces the identified sets of consecutive numbers with corrected sets of at least one consecutive number to produce a corrected at least one string of numbers. A character reconstruction element reconstructs the alphanumeric character from the corrected at least one string of numbers.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates an image preprocessing system comprising a contour correction component in accordance with an aspect of the present invention;

FIG. 2 is a sequence of images illustrating an alphanumeric character at four different stages in the contour correction process;

FIG. 3 illustrates a simplified representation of a system for identifying text on an envelope in accordance with an aspect of the present invention;

FIG. 4 illustrates an example of a methodology for correcting the contours of alphanumeric characters in accordance with an aspect of the present invention; and

FIG. 5 illustrates a computer system that can be employed to implement systems and methods described herein.

### DETAILED DESCRIPTION OF THE INVENTION

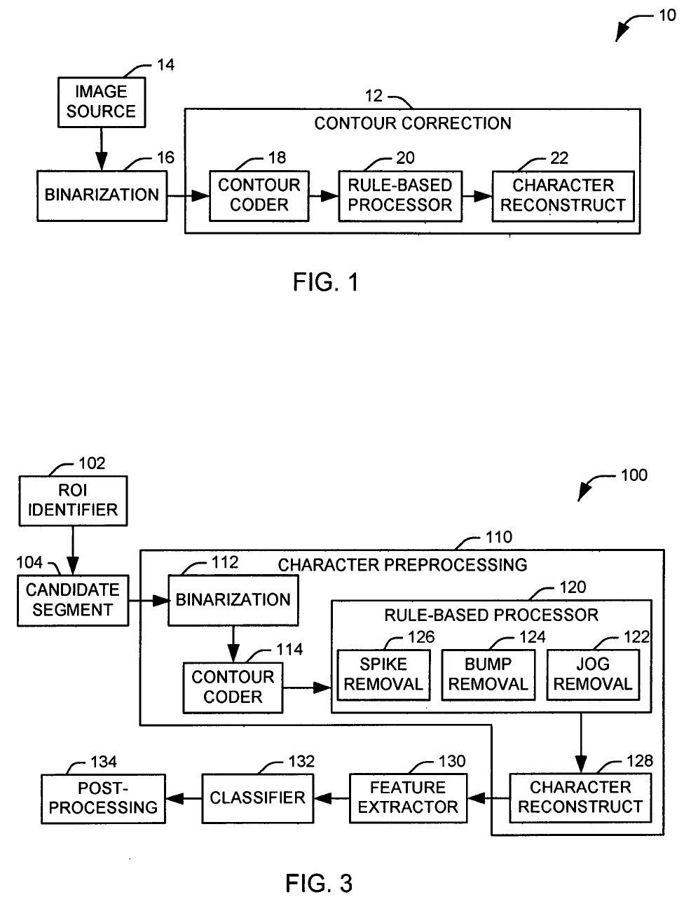

The present invention relates to systems and methods for the correction of character contours in an optical character recognition (OCR) system in accordance with an aspect of the present invention. FIG. 1 illustrates an image preprocessing system 10 comprising a contour correction component 12 that corrects defects in the contours of alphanumeric characters in accordance with an aspect of the present invention. The contour correction system 12 is operative to correct noise in an alphanumeric character caused by printing defects, binarization and scanning artifacts, and other common sources of aberration in imaged text. It will be appreciated that the system of FIG. 1 can be implemented as dedicated hardware, a software program stored on a computer readable medium and operative on a general purpose computer, or as some combination of hardware and software components.

A portion of an image containing an alphanumeric character is provided from an image source 14 to a binarization element 16. The binarization element 16 reduces the image portion to a binary image, containing only white pixels and black pixels. There are a number of binarization algorithms available for reducing a grayscale or color image to binary form. For example, the binarization element 16 can utilize locally adaptive algorithms such as Yanowitz/Bruckstein method or the Improved White/Rohrer method, globally adaptive algorithms such as the Otsu binarization method, and modified locally adaptive methods such as Niblack binarization or the Eikvil/Taxt/Moen method.

The binarized image is then provided to the contour correction component 12. A contour coder 18 traces the edges of the regions of black pixels within the image and generates at least one string of numerals that characterizes the shape of a given contour of the image. For example, the contour coder can utilize a Freeman chain code that codes the direction of the contour between consecutive pixels in the contour. In the Freeman chain code, a string of three pixels in the contour that are in a straight line, followed by a fourth pixel that is below the last of the string of three pixels might be coded as “335,” representing two transitions to the right, and one transition downward. It will be appreciated that some characters (e.g., the letter “O”) will have both interior and exterior contours, each of which can be corrected by the contour correction component 12.

The coded contour or contours are then provided to a rule-based processor 20. The rule based processor 20 searches the string of numerals for combinations of numbers that are determined to represent errors. For example, strings representing spikes, that is, pixel wide line segments that are connected to the character only at one end, corner bumps, which are single pixel extensions to an otherwise ninety-degree corner, and short, one-pixel, jogs in a longer run of pixels in a straight line. Once detected, these strings can be omitted or replaced to correct the character contours.

The corrected contours are then provided to a character reconstruction element 22 that reconstructs the character from the corrected contour. For example, in a letter “O”, the space between a corrected exterior contour and a corrected interior contour can be filled in to produce a corrected character. The reconstructed character can then be provided to one or more other elements of an optical character recognition system.

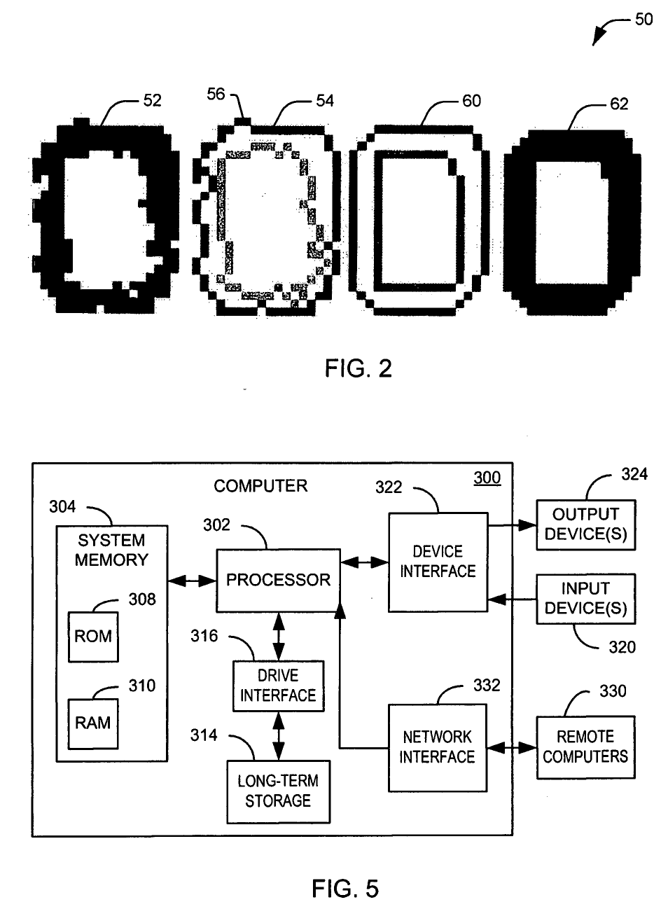

FIG. 2 is a sequence of images 50 illustrating an alphanumeric character at four different stages in the contour correction process. A first image 52 illustrates an uncorrected character from a digital scan. The first image 52 shows considerable artifact which could have resulted from any of a number of sources. A second image 54 illustrates the interior and exterior contours of the uncorrected character. It will be appreciated that the contours include several jogs (e.g., 56) that break otherwise straight runs of pixels.

A third image 60 represents a corrected representation of the contours of the image. In the third image 60, the corner bumps have been removed, and the lines of the contour have been smoothed to remove jags. A fourth image 62 illustrates the reconstructed character, with the region between the interior and the exterior contours filled with dark pixels. The reconstructed character can be utilized as an input to a classification system as a proxy for the original, uncorrected character to allow for reliable identification of the character.

FIG. 3 illustrates a simplified representation of a mail sorting system 100 that identifies text on an envelope in accordance with an aspect of the present invention. It will be appreciated that the time available to process a given envelope, including detection of at least the zip code and postage (e.g., metermark, stamp, etc.) on the envelope, must be accomplished within approximate one hundred milliseconds. To this end, the illustrated system 100 can utilize systems and methods in accordance with an aspect of the present invention to preprocess characters within an address within a few milliseconds to facilitate the recognition process. It is necessary that the characters be corrected for printing and scanning artifacts with great efficiency to retain time and processing resources for the downstream analysis of the envelope.

A image of an envelope is received at a region of interest (ROI) identifier 102 that determines the location of one or more regions of interest within the envelope image. The detected regions of interest can include address windows, mailing labels, and other likely candidates for a mailing address, text within stamps and metermarks, and other locations likely to contain text. In one implementation, the ROI identifier can scan a binarized image of the envelope for regions having a high density of dark pixels, although it will be appreciated that other algorithms are available.

In a candidate segmentation element 104, each region of interest is reviewed to locate one or more candidate objects within the region of interest. In the context of the character contour correction system in accordance with an aspect of the present invention, the candidate objects can include text characters that are detected within address blocks and postal indicia. When detected, the characters can be isolated and provided to a character preprocessor 110 in accordance with an aspect of the present invention.

The character preprocessing system 110 can include a binarization element 112 that reduces the image portion to a binary image, containing only white pixels and black pixels. It will be appreciated that a binarization on the scanned envelope can take place prior to this point (e.g., before region of interest extraction or segmentation), making this step of processing unnecessary.

A binarized character is then provided to a contour coder 114 that extracts one or more numerical codes representing at least one exterior contour of the character and any interior contours of the image. By the contour, it is meant a series of pixels on an extreme edge of the character (e.g., that border white space on at least one side) that are eight-connected to one another. For example, the letter “I” would have a single, exterior contour, the letter “i” would have two exterior contours, the letter “O” could have an exterior contour and an internal contour, the number “8” would have an exterior contour and two interior contours. Each contour is represented by a string of numerals, such as Freeman coding, to indicate the direction of transition between consecutive pixels within the contour.

The character codes are provided as numerical sequences to a rule-based processor 120 that corrects one or more defects in the strings of numbers. The rule-based processor 120 uses a series of logical rules to identify and remove defects represented by sequences of numbers in the coded contour. In one implementation, a jog removal element 122 can review the coded contours for sequences of numbers representing straight lines interrupted by brief departures, or jogs, from the straight line. For example, a sequence of numbers representing a transition diagonally up and to the right, one or two rightward transitions, and a transition diagonally down and to the right found in the midst of a series of rightward transitions would be identified as a jog.

A bump removal element 124 can review the coded contours for sequences of numbers representing corner bumps. For example, a corner bump can be identified as a sequence of numbers representing a diagonal deviation from an otherwise ninety degree corner. For example, a series of transitions that run up, diagonally up and left, diagonally down and right, and then right would be identified as a corner bump. Similarly, a spike removal element 126 can detect sequences of number representing relatively long, single pixel wide deviations from the contour. Any series of transitions of appropriate length that run in one direction and then return to the contour by the same path would be identified as a spike.

The corrected contours can then be provided to a character reconstruction element 128 that reconstructs the character from the corrected contour. For example, in a letter “O”, the space between a corrected exterior contour and a corrected interior contour can be filled in to produce a corrected character. The reconstructed character can be then be provided to one or more other elements of an optical character recognition system.

Each corrected character is provided to a feature extractor 130, where numerical feature values are extracted from the candidate objects as a feature vector. Each feature represents a quantifiable characteristic that is helpful in determining the identity of a given character. The features utilized by the feature extractor 130 can vary with the expected characteristics of the envelope text to produce. In one implementation, the feature extractor 130 can comprise a plurality of feature extractors, each optimized for a particular type of text (e.g., hand printed, hand written, or machine printed), such that the feature data extracted from each corrected character can be selected for maximum discriminant value.

The corrected characters are then classified into one of a plurality of output character classes according to the extracted feature vectors at a classification element 132. It will be appreciated that the classification element 132 can comprise a plurality of pattern recognition classifiers, each useful for distinguishing among different types of characters according to various sets of features. The classification element 132 can utilize one or more of neural networks, support vector machines, statistical classifiers, and similar classifiers in sorting the corrected characters into appropriate output classes.

The character class determined for each candidate object can then be provided to a post-processing element 134 that directs the processing of the envelope according to the determined output classes of the characters. For example, envelopes can be sorted according to their destination zip codes or rejected if the determined postage is found to be insufficient.

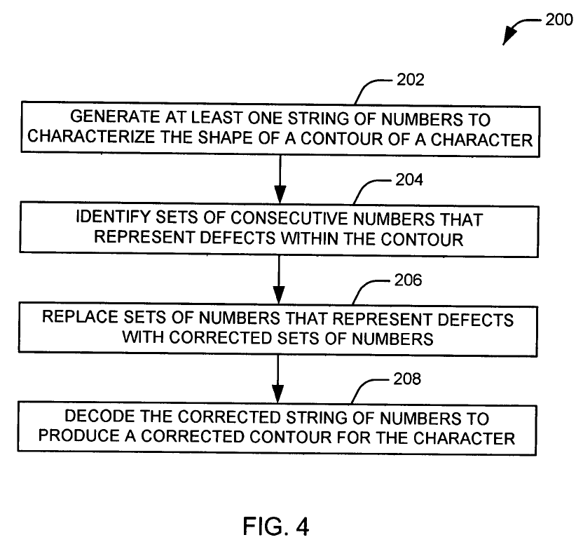

In view of the foregoing structural and functional features described above, methodologies in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates an example of a methodology 200 for correcting the contours of alphanumeric characters in accordance with an aspect of the present invention. At 202, at least one string of numbers is generated to characterize the shape of a given contour of an alphanumeric character. Each number within the string of numbers represents the direction of transition between consecutive pixels in the contour. For example, a Freeman chain encoding process can be utilized.

At 204, sets of consecutive numbers are identified within the string that represent defects in the contour. For example, sets of numbers within the image that might be identified as aberrations might represent pixel wide line segments that are connected to the alphanumeric character only at one end, single pixel extensions to otherwise ninety-degree corners, or short jogs within a longer, straight run of pixels. At 206, these sets of numbers can be replaced with corrected sets of at least one consecutive number to produce a corrected at least one string of numbers. At 208, the corrected at least one string of numbers can be decoded to construct a corrected contour for the alphanumeric character. The resulting image can then be provided as an input to an optical character recognition system.

FIG. 5 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN)) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for correcting contours of alphanumeric characters, comprising:
generating at least one string of numbers that characterizes a given contour of an alphanumeric character, each number within the string of numbers representing a direction of transition between consecutive pixels in the contour;
identifying sets of consecutive numbers within the string that represent defects in the contour; and
replacing the identified sets of consecutive numbers with corrected sets of at least one consecutive number to produce a corrected at least one string of numbers.

2. The method of claim 1, further comprising decoding the corrected at least one string of numbers to construct a corrected contour for the alphanumeric character.

3. The method of claim 1, wherein identifying sets of consecutive numbers within the string comprises identifying sets of numbers within the image that represent single pixel extensions to otherwise ninety-degree corners within the contour.

4. The method of claim 1, wherein identifying sets of consecutive numbers within the string comprises identifying sets of numbers within the image that represent pixel wide line segments that are connected to the alphanumeric character only at one end.

5. The method of claim 1, wherein identifying sets of consecutive numbers within the string comprises identifying sets of numbers within the image that represent short jogs within a longer, straight run of pixels.

6. The method of claim 1, wherein generating the at least one string of numbers comprises encoding the contour via Freeman chain coding.

7. An optical character recognition process, comprising:
scanning a plurality of alphanumeric characters as a respective plurality of digital images;
binarizing the plurality of digital images;
correcting the contours of the binarized plurality of images via the method of claim 1;
extracting respective sets of features from the corrected plurality of images; and
classifying each of the plurality of images as an alphanumeric character according to its associated set of extracted features.

8. The process of claim 7, wherein the scanned plurality of alphanumeric characters represent text on an envelope, and the process further comprises directing the processing of the envelope according to the classified plurality of images corresponding to the scanned plurality of alphanumeric characters.

9. A computer readable medium comprising computer executable instructions for correcting contours of alphanumeric characters, the computer executable instructions comprising:
a contour coder that generates at least one string of numbers that characterizes a given contour of an alphanumeric character, each number within the string of numbers representing a direction of transition between consecutive pixels in the contour;
a rule-based processor that identifies sets of consecutive numbers within the string that represent defects in the contour and replaces the identified sets of consecutive numbers with corrected sets of at least one consecutive number to produce a corrected at least one string of numbers; and
a character reconstruction element that reconstructs the alphanumeric character from the corrected at least one string of numbers.

10. The computer readable medium of claim 9, wherein the rule-based processor identifies sets of numbers within the image that represent single pixel extensions to otherwise ninety-degree corners within the contour.

11. The computer readable medium of claim 9, wherein the rule-based processor identifies sets of numbers within the image that represent pixel wide line segments that are connected to the alphanumeric character only at one end.

12. The computer readable medium of claim 9, wherein the rule-based processor identifies sets of numbers within the image that represent short jogs within a longer, straight run of pixels.

13. The computer readable medium of claim 9, the contour coder being operative to generate the at least one string of numbers via Freeman chain coding.

14. An optical character recognition system that classifies a digital image, comprising:
a binarization element that binarizes the digital image;
a character preprocessor, comprising:
a contour coder that generates at least one string of numbers that characterizes a given contour of an alphanumeric character, each number within the string of numbers representing a direction of transition between consecutive pixels in the contour; and
a rule-based processor that identifies sets of consecutive numbers within the string that represent defects in the contour and replaces the identified sets of consecutive numbers with corrected sets of at least one consecutive number to produce a corrected at least one string of numbers;
a feature extractor that extracts respective sets of features from the corrected plurality of images; and
a pattern recognition classifier that classifies each of the plurality of images as an alphanumeric character according to its associated set of extracted features.

15. The system of claim 14, the character preprocessor further comprising a character reconstruction element that reconstructs the alphanumeric character from the corrected at least one string of numbers.

16. The system of claim 14, wherein the rule-based processor comprises a bump removal element that identifies sets of numbers within the image that represent single pixel extensions to otherwise ninety-degree corners within the contour and replaces these sets of numbers with corrected sets of numbers.

17. The system of claim 14, wherein the rule-based processor comprises a spike removal element that identifies sets of numbers within the image that represent pixel wide line segments that are connected to the alphanumeric character only at one end and replaces the identified sets of numbers with corrected sets of numbers.

18. The system of claim 14, wherein the rule-based processor comprises a jog removal element that identifies sets of numbers within the image that represent short jogs within a longer, straight run of pixels and replaces the identified sets of numbers with corrected sets of numbers.

19. The system of claim 13, the contour coder being operative to generate the at least one string of numbers via Freeman chain coding.

20. A mail sorting system, comprising:
a region of interest identifier that locates regions containing alphanumeric characters on a scanned image of an envelope;
a candidate segmentation element that separates the scanned image of the envelope into digital images representing individual alphanumeric characters;
the optical character recognition system of claim 14; and
a post-processing element that directs the processing of the envelope according to the classified plurality of images corresponding to the plurality of alphanumeric characters associated with the envelope.
